(19) United States
(12) Patent Application Publication
(10) Pub. No.: US 2026/0067852 A1
(43) Pub. Date: Mar. 5, 2026

(54) COMMUNICATIONS METHODS, COMMUNICATION DEVICES, AND CORE NETWORK DEVICES

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN); Xinlei YU, Dongguan (CN)

(73) Assignee: GUANGDONG OPPO MOBILE TELECOMMUNICATIONS CORP., LTD., Dongguan (CN)

(21) Appl. No.: 19/156,255

(22) PCT Filed: Jul. 8, 2022
(86) PCT No.: PCT/CN2022/104573

§ 371 Date: Aug. 13, 2025

(51) Int. Cl. H04W 64/00; H04B 17/318; H04W 84/06

(52) U.S. Cl. CPC H04W 64/00; H04B 17/328; H04W 84/06

(57) ABSTRACT

Provided are communication methods, communication devices, and core network devices. A communication method comprises: a first device receiving a first message sent by a core network device, wherein the first message is used for instructing the first device to execute positioning measurements, and the positioning measurements comprise multiple measurements corresponding to different moments.

### CROSS-REFERENCE TO RELATED APPLICATIONS

This application is a national stage of International Application No. PCT/CN2022/104573, filed on Jul. 8, 2022, which is hereby incorporated by reference in its entirety

### TECHNICAL FIELD

This application relates to the field of communications technologies, and more specifically, to a communication method, a communications device, and a core network device.

### BACKGROUND

Currently, all positioning methods require that a plurality of access network devices participate in joint positioning measurement. However, the joint positioning measurement method has a specific requirement on a quantity of access network devices participating in joint positioning measurement. When there is only one access network device participating in joint positioning measurement, the joint positioning measurement method cannot be used, resulting in that positioning of a terminal device cannot be implemented.

### SUMMARY

This application provides a communications method, a communications device, and a core network device. The following describes various aspects related to this application.

According to a first aspect, a communication method is provided. The communication method includes: receiving, by a first device, a first message transmitted by a core network device, where the first message is used to instruct the first device to perform positioning measurement, and the positioning measurement includes a plurality of measurements corresponding to different instants.

According to a second aspect, a communication method is provided. The communication method includes: transmitting, by a core network device, a first message to a first device, where the first message is used to instruct the first device to perform positioning measurement, and the positioning measurement includes a plurality of measurements corresponding to different instants.

According to a third aspect, a communications device is provided. The communications device is a first device and includes: a receiving unit, configured to receive a first message transmitted by a core network device, where the first message is used to instruct the first device to perform positioning measurement, and the positioning measurement includes a plurality of measurements corresponding to different instants.

According to a fourth aspect, a core network device is provided, and the core network device includes: a transmitting unit, configured to transmit a first message to a first device, where the first message is used to instruct the first device to perform positioning measurement, and the positioning measurement includes a plurality of measurements corresponding to different instants.

According to a fifth aspect, a communications device is provided, where the communications device may be a first device and includes a processor, a memory, and a communications interface. The memory is configured to store one or more computer programs, and the processor is configured to invoke the computer program in the memory to cause the communications device to perform some or all of the steps of the method according to the first aspect.

According to a sixth aspect, a core network device is provided. The core network device includes a processor, a memory, and a communications interface, where the memory is configured to store one or more computer programs; and the processor is configured to invoke the computer program in the memory, to cause the core network device to perform some or all of the steps of the method in the second aspect.

According to a seventh aspect, an embodiment of this application provides a communications system, where the system includes the terminal device and/or the network device described above. In another possible design, the system may further include another device that interacts with the terminal device or the network device in the solutions provided in embodiments of this application.

According to an eighth aspect, an embodiment of this application provides a computer-readable storage medium. The computer-readable storage medium stores a computer program, and the computer program causes a terminal to perform some or all of the steps of the methods according to the foregoing aspects.

According to a ninth aspect, an embodiment of this application provides a computer program product. The computer program product includes a non-transitory computer-readable storage medium that stores a computer program, and the computer program is operable to cause a terminal to perform some or all of the steps of the methods according to the foregoing aspects. In some implementations, the computer program product may be a software installation package.

According to a tenth aspect, an embodiment of this application provides a chip. The chip includes a memory and a processor. The processor may invoke a computer program from the memory and run the computer program, to implement some or all of the steps described in the method according to the foregoing aspects.

In embodiments of this application, a core network device transmits a first message to a first device, to instruct the first device to perform positioning measurement, where the positioning measurement includes a plurality of measurements corresponding to different instants.

### BRIEF DESCRIPTION OF DRAWINGS

FIG. 1A to FIG. 1C are system architectural diagrams of communications systems to which embodiments of this application are applicable.

FIG. 2 is a schematic diagram of a satellite network architecture to which embodiments of this application are applicable.

FIG. 3 is a schematic diagram of another satellite network architecture to which embodiments of this application are applicable.

FIG. 4 is a schematic diagram of another satellite network architecture to which embodiments of this application are applicable.

FIG. 5 is a schematic diagram of a positioning architecture in a communications system to which embodiments of this application are applicable.

FIG. 6 is a schematic diagram of a measurement process of an RSTD measurement quantity to which embodiments of this application are applicable.

FIG. 7 is a schematic flowchart of a communication method according to an embodiment of this application.

FIG. 8 is a schematic diagram of a positioning process based on measurements at different instants according to an embodiment of this application.

FIG. 9 is a schematic diagram of a positioning process based on measurements at different instants according to another embodiment of this application.

FIG. 10 is a schematic diagram of a communications device according to an embodiment of this application.

FIG. 11 is a schematic diagram of a core network device according to an embodiment of this application.

FIG. 12 is a schematic structural diagram of a communications device according to an embodiment of this application.

### DESCRIPTION OF EMBODIMENTS

Technical solutions in this application are described below with reference to the accompanying drawings.

### Communications System Architecture

The technical solutions in embodiments of this application may be applied to various communications systems, for example, a global system for mobile communications (global system of mobile communication, GSM), a code-division multiple access (code division multiple access, CDMA) system, a wideband code-division multiple access (wideband code division multiple access, WCDMA) system, a general packet radio service (general packet radio service, GPRS), a long-term evolution (long term evolution, LTE) system, an advanced long-term evolution (advanced long term evolution, LTE-A) system, a new radio (new radio, NR) system, an evolved system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, a non-terrestrial network (non terrestrial network, NTN) system, a universal mobile telecommunications system (universal mobile telecommunication system, UMTS), a wireless local area network (wireless local area networks, WLAN), wireless fidelity (wireless fidelity, WiFi), a fifth-generation (5th-generation, 5G) system, or another communications system, for example, a future communications system such as a sixth-generation mobile communications system or a satellite communications system.

Generally, a quantity of connections supported by a conventional communications system is limited, and is also easy to implement. However, with development of communication technologies, a mobile communications system not only supports conventional communication, but also supports, for example, device-to-device (device to device, D2D) communication, machine-to-machine (machine to machine, M2M) communication, machine type communication (machine type communication, MTC), vehicle-to-vehicle (vehicle to vehicle, V2V) communication, or vehicle-to-everything (vehicle to everything, V2X) communication. Embodiments of this application may also be applied to these communications systems.

The communications system in embodiments of this application may be applied to a carrier aggregation (carrier aggregation, CA) scenario, a dual connectivity (dual connectivity, DC) scenario, or a standalone (standalone, SA) networking scenario.

The communications system in embodiments of this application may be applied to an unlicensed spectrum, and the unlicensed spectrum may also be considered as a shared spectrum. Alternatively, the communications system in embodiments of this application may be applied to a licensed spectrum, and the licensed spectrum may also be considered as a dedicated spectrum.

Embodiments of this application may be applied to an NTN system, or may be applied to a terrestrial communication network (terrestrial networks, TN) system. By way of example and without limitation, the NTN system includes an NR-based NTN system and an IoT-based NTN system.

Embodiments of this application are described with reference to a network device and a terminal device. The terminal device may also be referred to as a user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, a user apparatus, or the like.

In embodiments of this application, the terminal device may be a station (STATION, ST) in a WLAN, may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device or another processing device connected to a wireless modem, a vehicle-mounted device, a wearable device, a terminal device in a next-generation communications system such as an NR network, or a terminal device in a future evolved public land mobile network (public land mobile network, PLMN), or the like.

The terminal device in embodiments of this application may be a device providing a user with voice and/or data connectivity and capable of connecting people, objects, and machines, such as a handheld device or vehicle-mounted device having a wireless connection function. The terminal device in embodiments of this application may be a mobile phone (mobile phone), a tablet computer (Pad), a notebook computer, a palmtop computer, a mobile internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in smart grid (smart grid), a wireless terminal in transportation safety (transportation safety), a wireless terminal in smart city (smart city), a wireless terminal in smart home (smart home), or the like. Optionally, the terminal device may be configured to function as a base station. For example, the terminal device may function as a scheduling entity, which provides a sidelink signal between terminal devices in V2X, D2D, or the like. For example, a cellular phone and a vehicle communicate with each other through a sidelink signal. A cellular phone and a smart home device communicate with each other, without relaying a communication signal through a base station.

In embodiments of this application, the terminal device may be deployed on land, including being indoors or outdoors, may be handheld, wearable, or vehicle-mounted. The terminal device may be deployed on water (for example, on a ship), or may be deployed in the air (for example, on an airplane, an air balloon, or a satellite).

In embodiments of this application, the terminal device may be a mobile phone (mobile phone), a pad (pad), a computer with a wireless transceiver function, a virtual reality (virtual reality, VR) terminal device, an augmented reality (augmented reality, AR) terminal device, a wireless terminal device in industrial control (industrial control), a wireless terminal device in self driving (self driving), a wireless terminal device in remote medical (remote medical), a wireless terminal device in smart grid (smart grid), a wireless terminal device in transportation safety (transportation safety), a wireless terminal device in smart city (smart city), or a wireless terminal device in smart home (smart home), or the like. The terminal device involved in embodiments of this application may also be referred to as a terminal, a user equipment (user equipment, UE), an access terminal device, a vehicle-mounted terminal, an industrial control terminal, a UE unit, a UE station, a mobile site, a mobile station, a remote station, a remote terminal device, a mobile device, a UE terminal device, a wireless communications device, a UE agent, a UE apparatus, or the like. The terminal device may also be fixed or mobile.

By way of example rather than limitation, in embodiments of this application, the terminal device may alternatively be a wearable device. The wearable device may also be referred to as an intelligent wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, wearable smart devices may include a full-featured and large-sized device that can provide full or partial functions without relying on a smart phone, for example, a smart watch or smart glasses, and devices that focus on only a specific type of application function and need to cooperate with another device such as a smart phone for use, for example, various smart bracelets and smart jewelries for physical sign monitoring.

The network device in embodiments of this application may be a device configured to communicate with the terminal device. The network device may also be referred to as an access network device or a radio access network device. For example, the network device may be a base station. The network device in embodiments of this application may be a radio access network (radio access network, RAN) node (or device) that connects the terminal device to a wireless network. The base station may broadly cover the following various names, or may be replaced with the following names, such as a Node B (NodeB), an evolved NodeB (evolved NodeB, eNB), a next-generation NodeB (next generation NodeB, gNB), a relay station, an access point, a transmitting and receiving point (transmitting and receiving point, TRP), a transmitting point (transmitting point, TP), a master eNodeB MeNB, a secondary eNodeB SeNB, a multi-standard radio (MSR) node, a home eNodeB, a network controller, an access node, a radio node, an access point (access piont, AP), a transmission node, a transceiver node, a baseband unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), and a positioning node. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device-to-device D2D, vehicle-to-everything (vehicle-to-everything, V2X), and machine-to-machine (machine-to-machine, M2M) communications, a network-side device in a 6G network, a device that functions as a base station in a future communications system, or the like. The base station may support networks of a same access technology or different access technologies. A specific technology and a specific device used by the network device are not limited in embodiments of this application.

The base station may be a fixed or mobile base station. For example, a helicopter or an unmanned aerial vehicle may be configured to act as a mobile base station, and one or more cells may move based on a position of the mobile base station. In another example, a helicopter or an unmanned aerial vehicle may be configured to serve as a device in communication with another base station.

In some deployments, the network device in embodiments of this application may be a CU or a DU, or the network device may include a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario of the network device and the terminal device is not limited.

By way of example rather than limitation, in embodiments of this application, the network device may have a mobility characteristic. For example, the network device may be a mobile device. In some embodiments of this application, the network device may be a satellite or a balloon station. For example, the satellite may be a low earth orbit (low earth orbit, LEO) satellite, a medium earth orbit (medium earth orbit, MEO) satellite, a geostationary earth orbit (geostationary earth orbit, GEO) satellite, a high elliptical orbit (High Elliptical Orbit, HEO) satellite, or the like. In some embodiments of this application, the network device may alternatively be a base station located on land, water, or the like.

In embodiments of this application, the network device may provide a service for a cell, and the terminal device communicates with the network device by using a transmission resource (for example, a frequency domain resource or a spectrum resource) used by the cell. The cell may be a cell corresponding to the network device (for example, a base station). The cell may belong to a macro base station or belong to a base station corresponding to a small cell (small cell). The small cell herein may include a metro cell (metro cell), a micro cell (micro cell), a pico cell (pico cell), a femto cell (femto cell), or the like. These small cells feature small coverage and low transmit power, and are suitable for providing a high-speed data transmission service.

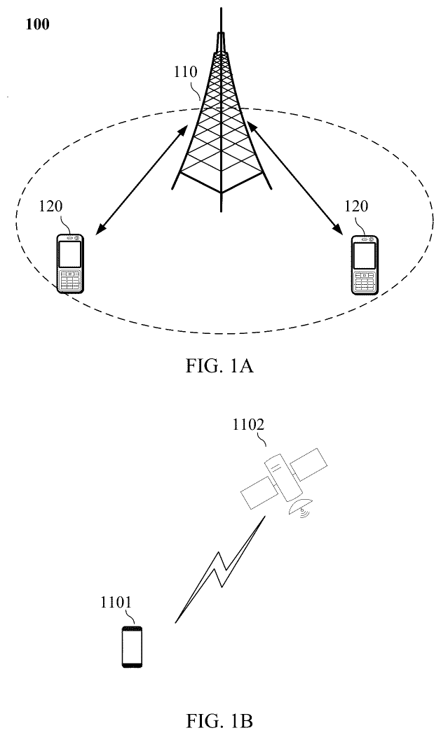

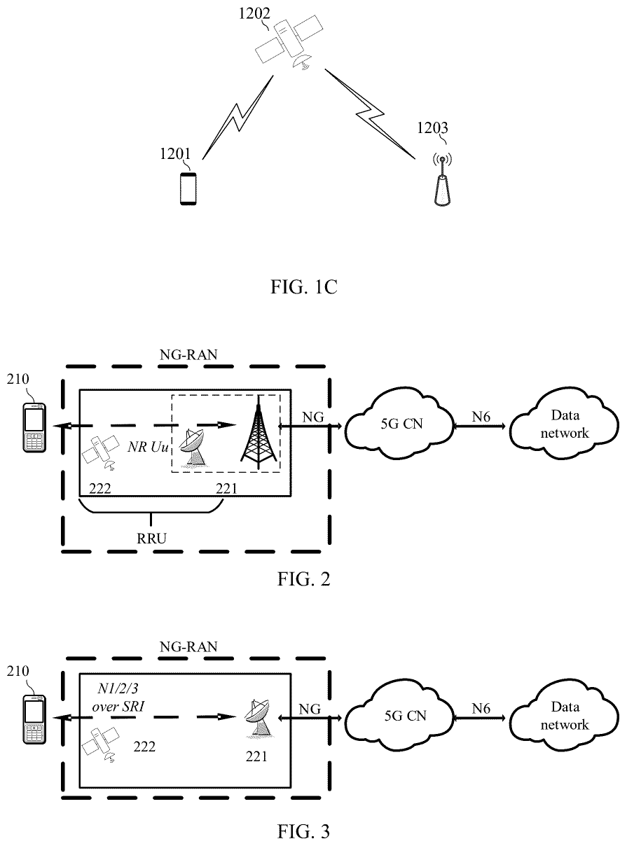

Exemplarily, FIG. 1A is a schematic diagram of an architecture of a communications system according to an embodiment of this application. As shown in FIG. 1A, the communications system 100 may include a network device 110, and the network device 110 may be a device that communicates with a terminal device 120 (or referred to as a communications terminal or a terminal). The network device 110 may provide communication coverage for a specific geographical area, and may communicate with a terminal device located within the coverage.

FIG. 1A exemplarily shows one network device and two terminal devices. In some embodiments of this application, the communications system 100 may include a plurality of network devices, and another quantity of terminal devices may be included within coverage of each network device, which is not limited in embodiments of this application.

Exemplarily, FIG. 1B is a schematic diagram of an architecture of another communications system according to an embodiment of this application. Referring to FIG. 1B, a terminal device 1101 and a satellite 1102 are included, and wireless communication may be performed between the terminal device 1101 and the satellite 1102. A network formed between the terminal device 1101 and the satellite 1102 may also be referred to as an NTN. In the architecture of the communications system shown in FIG. 1B, the satellite 1102 may have a function of a base station, and direct communication may be performed between the terminal device 1101 and the satellite 1102. In the system architecture, the satellite 1102 may be referred to as a network device. In some embodiments of this application, the communications system may include a plurality of network devices 1102, and another quantity of terminal devices may be included within coverage of each network device 1102, which is not limited in embodiments of this application.

Exemplarily, FIG. 1C is a schematic diagram of an architecture of another communications system according to an embodiment of this application. Referring to FIG. 1C, a terminal device 1201, a satellite 1202, and a base station 1203 are included, wireless communication may be performed between the terminal device 1201 and the satellite 1202, and communication may be performed between the satellite 1202 and the base station 1203. A network formed between the terminal device 1201, the satellite 1202, and the base station 1203 may also be referred to as an NTN. In the architecture of the communications system shown in FIG. 1C, the satellite 1202 may not have a function of a base station, and communication between the terminal device 1201 and the base station 1203 is required to be relayed by using the satellite 1202. In the architecture of the system, the base station 1203 may be referred to as a network device. In some embodiments of this application, the communications system may include a plurality of network devices 1203, and another quantity of terminal devices may be included within coverage of each network device 1203, which is not limited in embodiments of this application.

It should be noted that FIG. 1A to FIG. 1C are merely examples of systems to which this application is applicable. Certainly, the methods shown in embodiments of this application may also be applied to another system, such as a 5G communications system or an LTE communications system. This is not specifically limited in embodiments of this application.

In some embodiments of this application, the wireless communications systems shown in FIG. 1A to FIG. 1C may further include another network entity such as a mobility management entity (mobility management entity, MME) or an access and mobility management function (access and mobility management function, AMF), which is not limited in embodiments of this application.

It should be understood that in embodiments of this application, a device having a communication function in a network or a system may be referred to as a communications device. The communications system 100 shown in FIG. 1A is used as an example. The communications device may include a network device 110 and a terminal device 120 that have a communication function. The network device 110 and the terminal device 120 may be the foregoing specific devices, and details are not described herein again. The communications device may further include another device in the communications system 100, such as a network controller or a mobility management entity. This is not limited in embodiments of this application.

It should be understood that, in embodiments of this application, “indication” mentioned herein may refer to a direct indication, or may refer to an indirect indication, or may mean that there is an association relationship. For example, if A indicates B, it may mean that A directly indicates B, for example, B can be obtained from A. Alternatively, it may mean that A indirectly indicates B, for example, A indicates C, and B can be obtained from C. Alternatively, it may mean that there is an association relationship between A and B.

In descriptions of embodiments of this application, the term “corresponding” may mean that there is a direct or indirect correspondence between two elements, or that there is an association relationship between two elements, or that there is a relationship of “indicating” and “being indicated”, “configuring” and “being configured”, or the like.

“Configured” in embodiments of this application may include being configured by using at least one of system information, radio resource control (radio resource control, RRC) signalling, or a medium access control control element (media access control control element, MAC CE).

In some embodiments of this application, “predefined” or “preset” may be implemented by pre-storing corresponding codes, tables, or other forms that can be used to indicate related information in devices (for example, including a terminal device and a network device), and a specific implementation thereof is not limited in this application. For example, being predefined may refer to being defined in a protocol.

In some embodiments of this application, the “protocol” may refer to a standard protocol in the communication field, which may include, for example, an LTE protocol, an NR protocol, and a related protocol applied to a future communications system. This is not limited in this application.

For ease of understanding, some relevant technical knowledge related to embodiments of this application is first described. The following related technologies, as optional solutions, may be randomly combined with the technical solutions in embodiments of this application, all of which fall within the protection scope of embodiments of this application. Embodiments of this application include at least a part of the following content.

### NTN

Currently, the 3rd generation partnership project (3rd generation partnership project, 3GPP) is currently researching NTN technologies. An NTN generally provides a communication service for a terrestrial user through satellite communication. The satellite communication has many advantages over terrestrial communication networks (such as a terrestrial cellular communication).

First, the satellite communication is not limited by a geographic location of a user. For example, a general terrestrial communication network cannot cover an area such as an ocean, a mountain, or a desert in which a network device cannot be set up. Alternatively, the terrestrial communications network does not cover some areas that are sparsely populated. However, for the satellite communication, since one satellite may cover a relatively large terrestrial area, and the satellite may orbit the earth, theoretically, every position on the earth may be covered by a satellite communication network.

Second, satellite communication has great social value. Satellite communication may cover remote mountainous areas, impoverished countries or regions at relatively low costs, thereby enabling people in these regions to enjoy advanced voice communication and mobile internet technologies. From this point of view, satellite communication is conducive to narrowing a digital divide with developed regions and promoting development of these regions.

Third, satellite communication has an advantage of a long distance, and an increase in the communication distance does not significantly increase a communication cost.

Finally, the satellite communication has high stability, and is not affected by natural disasters.

Communications satellites are classified into a low earth orbit (low earth orbit, LEO) satellite, a medium earth orbit (medium earth orbit, MEO) satellite, a geostationary earth orbit (geostationary earth orbit, GEO) satellite, a high elliptical orbit (high elliptical orbit, HEO) satellite, and the like according to different orbital altitudes. At this stage, the LEO satellite and the GEO satellite are mainly studied.

An altitude of the LEO satellite generally ranges from 500 km to 1500 km. Correspondingly, an orbital period of the LEO satellite is about 1.5 hours to 2 hours. For the LEO satellite, a signal propagation delay of single-hop communication between users is generally less than 20 ms. A maximum satellite visible time of the LEO satellite is about 20 minutes. The LEO satellite has advantages of a short signal propagation distance, a small link loss, and a low transmit power requirement for a terminal device of a user.

An orbital altitude of the GEO satellite is 35,786 km. A period for the GEO satellite to rotate around the earth is 24 hours. For the GEO satellite, a signal propagation delay of single-hop communication between users is generally about 250 ms.

To ensure satellite coverage and improve a system capacity of an entire satellite communications system, a satellite usually uses a plurality of beams to cover a terrestrial area. Therefore, one satellite may generate dozens or even hundreds of beams to cover the terrestrial area. One beam of a satellite may cover a terrestrial area with a diameter of approximately tens to hundreds of kilometers.

Currently, an NTN system includes an NR-NTN system and an Internet of Things (internet of things, IoT)-NTN system.

### Satellite Network Architecture

Currently, 3GPP considers two types of satellites: one is a transparent payload (transparent payload) satellite, and the other is a regenerative payload (regenerative payload) satellite. With reference to FIG. 2 to FIG. 4, the following separately describes a network architecture including a transparent payload satellite and a network architecture including a regenerative payload satellite.

In the satellite network architecture shown in FIG. 2 to FIG. 4, the satellite network architecture may include a terminal device 210, a satellite node 222, and a terrestrial receiving station 221 (“terrestrial station” for short). There is wireless communication between the terminal device 210 and the satellite node 222, and the terminal device 210 may transmit data to the satellite node 221 over a link between the terminal device 210 and the satellite node 221. For example, the terminal device 210 may transmit data to the satellite node 221 over a service link (service link). Accordingly, after receiving the data, the satellite node 221 may transmit the data to the terrestrial receiving station 222 over a link between the satellite node 221 and the terrestrial receiving station 222. For example, the satellite node 222 may transmit the data to the terrestrial receiving station 221 over a radio link (for example, a feeder link (feeder link)). Accordingly, after receiving the data from the satellite node 222, the terrestrial receiving station 221 transmits the data to a core network (data network), and further processes the data by using the core network, for example, performs data interaction with another terminal. It may be understood that the service link herein refers to the link between the terminal device 210 and the satellite node 222, and the feeder link refers to the link between the satellite node 222 and the terrestrial receiving station 221. In another possible embodiment, the link between the terminal device and the satellite node and/or the link between the satellite node and the terrestrial receiving station may also be represented by another term, which is not limited in this application.

The satellite node 222 may be classified into three types. A first type of satellite node is used only for forwarding, that is, having only a transparent payload function. In some implementations, such a satellite node may provide only one or more of a radio frequency filtering function, a frequency conversion function, or a power amplification function. For such a satellite node, a signal received from a terminal device may be amplified and then transmitted to the terrestrial receiving station. No processing is performed on the signal of the terminal device at the satellite node, as shown in FIG. 2. The terminal device may communicate with the satellite node by using an NR-Uu interface, the satellite node may communicate with the terrestrial receiving station (for example, may include an NTN remote radio unit (remote radio unit, RRU) and a gNB) by using an NR-Uu interface, the terrestrial receiving station may communicate with a 5G core network (5G CN) by using an N1 interface, an N2 interface, or an N3 interface, and the 5G CN may communicate with a data network by using an N6 interface.

A second type of satellite node has a complete processing function of a base station. For a terrestrial terminal device, the satellite node is a base station, and communication between the satellite node and the terminal device is substantially consistent with normal 5G communication, as shown in FIG. 3. In some implementations, such a satellite node may further provide one or more of the following functions: a demodulation function, a decoding function, a routing function, a conversion function, an encoding function, or a modulation function. The terminal device may communicate with the satellite node by using an NR-Uu interface. The satellite node may communicate with the terrestrial receiving station by using a satellite radio interface (satellite radio interface, SRI). The SRI interface may be used to transmit an interface message (for example, an N2 or N3 interface message) between the satellite node and a 5G CN. The terrestrial receiving station may communicate with the 5G CN by using an N1 interface, an N2 interface, or an N3 interface, and the 5G CN may communicate with a data network by using an N6 interface.

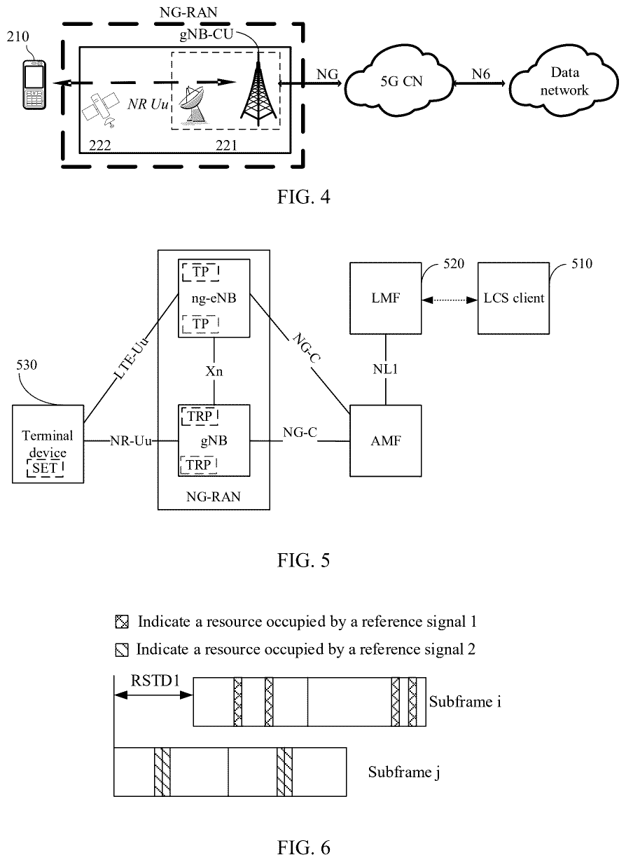

A third type of satellite node has a DU processing function. The satellite node is a DU for a terrestrial terminal device. Communication between the satellite node and the terminal device is substantially the same as communication between a terminal device and a DU in a normal 5G terrestrial communications system, as shown in FIG. 4. The terminal device may communicate with the satellite node by using an NR-Uu interface. The satellite node may communicate with a terrestrial receiving station (for example, may include a gNB-CU) by using an SRI interface. The SRI interface may be used for transmitting an F1 interface message between the satellite and the terrestrial receiving station. The terrestrial receiving station may communicate with a 5G CN by using an N1, N2, or N3 interface. The 5G CN may communicate with a data network by using an N6 interface.

### Positioning Architecture and Interface Protocol

Currently, a communications system (including the NTN system described above) may provide a terminal device with a location service (location service, LCS), also referred to as a “positioning service”. For ease of understanding, the following describes a positioning architecture in a communications system with reference to FIG. 5.

Referring to FIG. 5, the positioning architecture may include an LCS client (LCS client) 510, an LCS server (LCS server) 520, and an LCS target (LCS target) 530.

The LCS target 530, also referred to as a “positioning target”, generally may be a terminal device. In some scenarios, the terminal device may perform measurement as required, and collect some data of location information.

The LCS server 520, also referred to as a “positioning server”, may be understood as an entity that performs positioning of an LCS target device, and is responsible for providing assistance information and performing location calculation. In a communications system, the LCS server may include a location management function (location management function, LMF) device.

The LCS client 510 may represent an entity that interacts with the LCS server 520 to obtain an LCS target location. The LCS client 510 transmits a request for obtaining location data to the LCS server 520. After processing the request, the LCS server transmits a positioning result to the LCS client 510. In some implementations, the LCS client may transmit a positioning request to an LMF by using an AMF.

In a positioning process, if the LMF receives the positioning request transmitted by the LCS client, the LMF may initiate a positioning procedure to the terminal device and an access network device, for example, acquiring location-related measurement and assistance information.

Currently, positioning protocols supported in communications protocols include an LTE positioning protocol (LTE positioning protocol, LPP) and an NR positioning protocol a (NR positioning protocol a, NRPPa). The LPP may be used as a general positioning communication protocol, and is mainly used for interaction of positioning capability information, assistance data, positioning-related measurement information, location information, and the like between the LCS server and the terminal device. Generally, the LPP supports point-to-point communication between the terminal device and the LCS server. In addition, the LPP may be used for user plane positioning and control plane positioning, and allow a plurality of LPP processes to be performed simultaneously to reduce positioning delay. Currently, the NRPPa is commonly used for control plane positioning, and supports communication between the access network device and the LCS server. The NRPPa may assist the user plane in positioning by querying data and measurement of the access network device.

### Positioning Method

Currently, there are many common positioning methods, for example, a time of arrival (time of arrival, TOA)-based positioning method, and a time difference of arrival (time difference of arrival, TDOA)-based positioning method. Currently, compared with a TOA-based positioning method, a TDOA-based positioning method has a relatively low requirement for synchronization accuracy between a terminal device and a network device. Therefore, the TDOA-based positioning method is widely used. The following uses a TDOA-based positioning method as an example for description.

According to the TDOA-based positioning method, a location of a terminal device is calculated, in a case that a location of each access network device is known, by measuring a time difference of arrival of two or more signals (for example, reference signal (reference signal, RS)) by using a positioning principle similar to that of a GNSS.

Currently, the TDOA-based positioning method may be classified into two types according to types of measurement signals: an observed time difference of arrival (observed time difference of arrival, OTDOA) method and an uplink time difference of arrival (uplink time difference of arrival, UTDOA) method. In the OTDOA method, a terminal device measures a downlink reference signal from an access network device, and in the UTDOA method, an access network device measures an uplink reference signal from a terminal device.

The OTDOA positioning method was originally defined in the universal mobile telecommunications system (universal mobile telecommunications system, UMTS), and was standardized by 3GPP in 1999. Based on a distance measurement value obtained from a common pilot channel (common pilot channel, CPICH) signal, a location may be calculated on an LCS server or a mobile device (for example, a terminal device) by using assistance data. The LTE standard specified the OTDOA method in 2009, and a distance measurement value is calculated by a mobile device by using a dedicated pilot signal used for positioning, namely, a position reference signal (position reference signal, PRS).

A 3GPP LTE system is used as an example to describe the OTDOA positioning principle. A terminal device may measure a downlink reference signal of an eNodeB to obtain a time difference of arrival of signals, namely, a reference signal time difference (reference signal time difference, RSTD), from different eNodeBs to the terminal device. Then, the terminal device transmits the RSTD to an LMF. Correspondingly, the LMF estimates a location of the terminal device based on a measurement result and with reference to a location of the eNodeB. Generally, a location estimation method requires at least three eNodeBs. More eNodeB data measured by the terminal device indicates higher the measurement precision and better positioning performance.

The UTDOA method was standardized in a 3G system in Release 7 in 2005 and then standardized in an LTE-A system in Release 12 in 2012. For the UTDOA method, an eNodeB must communicate with a terminal device first, and the terminal device is required to transmit a sounding reference signal (sounding reference signal, SRS) at a specific time as a measurement of a UTDOA.

Currently, DL-TDOA positioning and UL-TDOA positioning are introduced in an NR system, and a principle thereof is similar to that of the OTDOA and UTDOA methods. For ease of understanding, the following describes a measurement process of an RSTD measurement quantity by using the DL-TDOA as an example with reference to FIG. 6.

Referring to FIG. 6, it is assumed that a TRP 0 and a TRP 1 participate in positioning measurement of a terminal device, and the TRP 0 transmits a reference signal 1 to the terminal device, where the reference signal 1 is carried in a subframe i. The TRP 1 transmits a reference signal 2 to the terminal device, where the reference signal 2 is carried in a subframe j.

Correspondingly, the terminal device records a receiving time of a start position of the subframe i as an arrival time of the reference signal 1, and records a receiving time of a start position of the subframe j as an arrival time of the reference signal 2. Then, the terminal device calculates a reference signal time difference RSTD 1 between the reference signal 1 and the reference signal 2 based on the arrival time of the reference signal 1 and the arrival time of the reference signal 2.

Currently, all positioning methods require that a plurality of access network devices participate in joint positioning measurement. However, the joint positioning measurement method has a specific requirement on a quantity of access network devices participating in joint positioning measurement. When there is only one access network device participating in joint positioning measurement, the joint positioning measurement method cannot be used, resulting in that positioning of a terminal device cannot be implemented.

For example, in an NTN scenario, a terminal device may generally measure a reference signal transmitted by only one satellite node (or “satellite”), or the terminal device may transmit, to only one satellite node, a reference signal used for positioning. In this scenario, an access network device that participates in positioning measurement may be only one satellite. In this case, the terminal device cannot be positioned by using the joint positioning measurement method, resulting in positioning failure of the terminal device.

Therefore, to avoid the foregoing problem, an embodiment of this application provides a communication method, in which a terminal device may be positioned based on a plurality of measurements at different instants. When the positioning method based on measurements at different instants is used for positioning the terminal device, there may be one or more access network devices participating in positioning, thus improving a success rate of positioning the terminal device.

As described above, in the positioning method based on measurements at different instants, there may be one or more access network devices participating in positioning. In some implementations, when there is one access network device participating in positioning, the access network device may be a mobile access network device. For ease of understanding, the following uses an example in which a satellite in an NTN system is a mobile access network device, to describe cases that there is one or more access network devices participating in positioning.

Case 1: In an NTN system, a satellite may generally move according to a preset trajectory. In this case, when a terminal device is positioned by using the positioning method that is based on measurements at different instants, the satellite may exactly move to different locations at different instants. Therefore, the satellite located at different locations at different instants may simulate a plurality of network devices in a scenario of joint positioning measurement, that is, one satellite located at different locations at different instants may simulate a plurality of access network devices located at different locations. In this case, although only one satellite participates in positioning measurement, the foregoing joint positioning measurement method may be used to position the terminal device.

Case 2: In an NTN system, a satellite may generally move according to a preset trajectory, where a moving direction may be a direction away from a terminal device. In this scenario, to ensure communication quality, the terminal device usually performs cell handover, for example, is handed over from a satellite to which a source cell belongs to a satellite to which a target cell belongs. In this case, when the terminal device is positioned by using the positioning method that is based on measurements at different instants, a satellite that participates in positioning measurement may include the satellite to which the source cell belongs and the satellite to which the target cell belongs. In this case, the satellite to which the source cell belongs and the satellite to which the target cell belongs may simulate a plurality of network devices located at different locations in a scenario of joint positioning measurement.

It should be noted that, as a low-orbit satellite has a feature of high-speed moving, the satellite in embodiments of this application may be a low-orbit satellite. Certainly, in embodiments of this application, the satellite may be any type of satellite.

In addition, in embodiments of this application, a positioning method on which the positioning measurement is based is not limited. For example, the positioning method on which the positioning measurement is based may include a TOA-based positioning method and/or a TDOA-based positioning method.

Generally, in a process of positioning a terminal device by using joint positioning measurement, a larger position difference between a plurality of access network devices indicates higher positioning accuracy of the terminal device. Therefore, to improve positioning accuracy of the terminal device, locations of the access network devices that participate in positioning measurement at different instants may be adjusted by adjusting time intervals between a plurality of measurements (also referred to as “measurement time intervals”). For example, the time intervals between the plurality of measurements may be set to different time intervals, so as to increase location differences of access network devices at different instants. In an example of an NTN system, a satellite moves according to a preset orbit. Therefore, the time intervals between a plurality of measurements may be set to different time intervals, to increase differences of positions of the satellite on the orbit at different instants. Certainly, in embodiments of this application, the time intervals between the plurality of measurements may alternatively be equal, that is, the plurality of measurements may be equal-interval measurements.

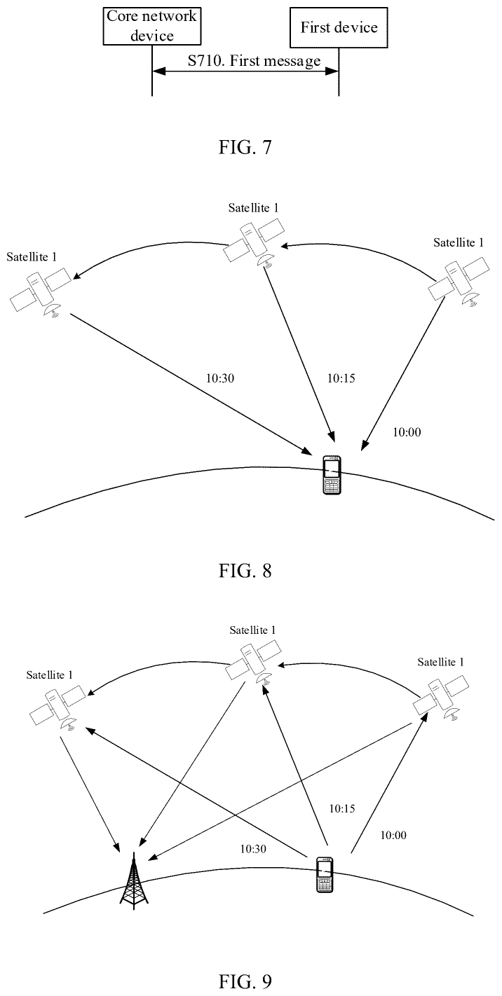

In embodiments of this application, information (hereinafter referred to as “a first message”) indicating that positioning method based on measurements at different instants is used may be transmitted by a core network device (for example, an LMF) to a terminal device or an access network device that participates in positioning (hereinafter collectively referred to as “a first device”). A communication method according to an embodiment of this application is described below with reference to FIG. 7. The method shown in FIG. 7 includes step S710.

In step S710, a core network device transmits a first message to a first device, where the first message is used to instruct the first device to perform positioning measurement.

The positioning measurement may include a plurality of measurements corresponding to different instants. As described above, the plurality of measurements may be performed based on one satellite, or the plurality of measurements may be performed based on a plurality of measurements.

As described above, a positioning measurement currently may include a downlink signal (for example, a downlink reference signal)-based positioning measurement and an uplink signal (for example, an uplink reference signal)-based positioning measurement. In addition, the downlink signal-based positioning measurement may be performed by a terminal device. In other words, in this scenario, the first device may include the terminal device. Correspondingly, the uplink signal-based positioning measurement may be performed by an access network device. In other words, in this scenario, the first device may include the access network device. The following describes the downlink signal-based positioning measurement and the uplink signal-based positioning measurement with reference to Embodiment 1 and Embodiment 2. For brevity, details are not described herein again.

As described above, in a positioning scenario, interaction between the core network device and the terminal device may be specified by using the LPP. Therefore, if the first device includes the terminal device, the first message may be an LPP message.

Correspondingly, interaction between the core network device and the access network device may be specified by using the NRPPa. Therefore, if the first device includes the access network device, the first message may be an NRPPa message.

The following describes content that may be included in the first message in embodiments of this application. It should be noted that the first message may further include information other than the following information, which is not limited in embodiments of this application.

In some implementations, the first message may include a measurement time interval between different measurements in a plurality of measurements.

A manner of calculating the measurement time interval is not specifically limited in embodiments of this application. In an example, the measurement time interval may include a time interval between adjacent measurements in the plurality of measurements. For example, the plurality of measurements include a first measurement and a second measurement adjacent to the first measurement. In this case, the measurement time interval may refer to a measurement time interval between the first measurement and the second measurement.

In another example, the measurement time interval may further include a time interval between a measurement other than an initial measurement in the plurality of measurements and the initial measurement. For example, the plurality of measurements include a first measurement, a second measurement and a third measurement, and the first measurement is the initial measurement in the plurality of measurements. In this case, the measurement time interval may include a measurement time interval between the second measurement and the first measurement, and a measurement time interval between the third measurement and the first measurement. A manner of calculating the measurement time interval is not specifically limited in embodiments of this application.

In addition, a manner in which the first message indicates the measurement time interval is not limited in embodiments of this application. In an example, the first message may indicate the measurement time interval by using a specific time length. For example, the first message may indicate the measurement time interval by using 5s.

In another example, the first message may indicate a measurement time interval between different measurements by using a quantity of time domain units included between different measurements. The time domain unit, for example, may be a subframe (subframe), a radio frame (radio frame), a slot (slot), a symbol (symbol), or the like. Certainly, the time domain unit may be another time domain resource division unit defined in a future communications system, which is not limited in embodiments of this application.

The time domain units included between different measurements may be one type of time domain units, or may be a plurality of types of time domain units. In an example in which the time domain unit is a subframe, the first message indicates a measurement time interval between different measurements by using 10 radio frames. In other words, the measurement time interval between different measurements is 10 radio frames. In an example in which the time domain unit includes a subframe and a slot, the first message indicates a measurement time interval between different measurements by using two subframes and five symbols. In other words, the measurement time interval between different measurements is two subframes and five symbols.

For ease of understanding, the following describes a measurement time interval in embodiments of this application with reference to a manner of indicating the measurement time interval and a manner of calculating the measurement time interval.

In an example in which the measurement time interval may include a time interval between adjacent measurements, if the first message indicates that a measurement time interval Δt1 is 5s, the time interval between adjacent measurements in the plurality of measurements is 5s.

In an example in which the measurement time interval includes a time interval between the initial measurement and a measurement other than the initial measurement, if the first message indicates that time intervals between respective measurements and an initial measurement (namely, the first measurement) are Δt2, Δt3, and Δt4 that are different from each other, a measurement time interval between the second measurement in a plurality of measurements and the initial measurement is Δt2, a measurement time interval between the third measurement in a plurality of measurements and the initial measurement is Δt2, and a measurement time interval between the fourth measurement in a plurality of measurements and the initial measurement is Δt4.

In an example in which the measurement time interval may include a time interval between adjacent measurements, if the first message indicates that the measurement time interval is four radio frames and five subframes (equivalent to 45 subframes), the time interval between adjacent measurements in the plurality of measurements is four radio frames and five subframes.

In some implementations, the first message may include a quantity of measurement times of the plurality of measurements. For example, the first message may include a quantity of measurement times for the plurality of measurements being five, that is, the positioning measurements for the terminal device include five times of measurements at different instants.

In some implementations, the first message may include a quantity of times of measurements performed by the first device in the plurality of measurements.

One measurement may be performed by the first device in the plurality of measurements. For example, when the uplink signal-based positioning measurement is performed in the cell handover scenario described above, a satellite to which a source cell belongs may perform measurement only once, and a satellite to which a target cell belongs may perform measurement only once.

More than one measurements may be performed by the first device in the plurality of measurements. For example, when the uplink signal-based positioning measurement is performed in the single satellite scenario described above, the plurality of measurements may be performed by one satellite. Therefore, a quantity of measurement times performed by the first device is the same as a quantity of measurement times of the plurality of measurements in the positioning measurement. For another example, when the downlink signal-based positioning measurement is performed in the single satellite scenario described above, the plurality of measurements may be performed by the terminal device. Therefore, a quantity of measurement times performed by the terminal device is the same as a quantity of measurement times of the plurality of measurements in the positioning measurement.

In some implementations, the first message may include total measurement duration of the plurality of measurements. That is, the plurality of measurements end when the total measurement duration expires.

In some implementations, the first message may include a measurement end time of the plurality of measurements. That is, when the measurement end time is reached, the plurality of measurements end.

In some implementations, the first message may include a measurement response time of the plurality of measurements, where the measurement response time is a time at which the first device transmits a measurement result of the positioning measurement to the core network device

In some implementations, the first message may include indication information of a manner for determining a first measurement value of the plurality of measurements.

The indication information is used to indicate one or more of the following: the first measurement value of the positioning measurement being determined based on adjacent measurements in the plurality of measurements; or the first measurement value of the positioning measurement being determined based on a measurement other than an initial measurement in the plurality of measurements and the initial measurement. The positioning measurement may include one or more first measurement values, which is not limited in embodiments of this application.

The first measurement value of the positioning measurement is determined based on adjacent measurements in the plurality of measurements. It may be understood that a measurement value (namely, the first measurement value) in the positioning measurement may be determined based on adjacent measurements in the plurality of measurements. In an example in which the first measurement value is an RSTD, the first measurement value may be a difference between arrival times of a reference signal obtained through two adjacent measurements.

The first measurement value of the positioning measurement is determined based on another measurement and an initial measurement. It may be understood that a measurement value (namely, the first measurement value) in the positioning measurement may be determined based on a measurement relative to the initial measurement. In an example in which the first measurement value is an RSTD, the first measurement value may be a difference between an arrival time of a reference signal obtained through the Nth measurement and an arrival time of a reference signal obtained through the initial measurement in the plurality of measurements, where N is a positive integer greater than 1.

In addition, in some implementations, the initial measurement may not provide a measurement quantity, or a measurement quantity of the initial measurement is a specified value (for example, 0). Certainly, in embodiments of this application, the measurement quantity of the initial measurement may be an actual measurement value of the initial measurement, which is not limited in embodiments of this application.

It should be noted that, in embodiments of this application, the arrival time of the reference signal mentioned above may be a receiving instant of a start position corresponding to the reference signal. In some implementations, the start position corresponding to the reference signal may be a start position of a time domain resource occupied by the reference signal. For example, if the time domain resource occupied by the reference signal is a symbol 1, the start position corresponding to the reference signal may be a start position of the symbol 1. In some other implementations, the start position corresponding to the reference signal may be a start position of a time domain unit that carries the reference signal. In an example in which the time domain unit is a subframe, the start position corresponding to the reference signal may be a start position of a subframe that carries the reference signal, as shown in FIG. 6. In an example in which the time domain unit is a radio frame, the start position corresponding to the reference signal may be a start position of a radio frame that carries the reference signal. Certainly, in embodiments of this application, the arrival time of the reference signal may alternatively refer to a receiving instant at an end position of the reference signal, which is not limited in embodiments of this application.

In an example in which the time domain unit is a subframe, the terminal device may determine a start position of a subframe in a measured cell by using one or more of an SSB signal, a TRS signal, or a CSI-RS signal. Certainly, in embodiments of this application, the terminal device may further measure the start position of the time domain unit in a cell in another manner.

In addition, the first message may include one or more of the foregoing information, which is not limited in embodiments of this application. When the first message includes the plurality of types of information, the plurality of types of information may be combined to determine other information. For example, if the first message includes measurement duration and the measurement time interval of the plurality of measurements, a quantity of measurement times of the plurality of measurements may be determined based on the measurement duration and the measurement time interval of the plurality of measurements.

The foregoing describes a process in which the core network device transmits the first message to the first device, and content included in the first message. The following separately describes a DL-TDOA-based positioning measurement process and a UL-TDOA-based positioning measurement process with reference to Embodiment 1 and Embodiment 2. It should be noted that, in a positioning measurement process, a positioning measurement parameter may be indicated by the first message, or may be indicated by another manner (for example, predefined). For ease of understanding, the following uses an example in which a positioning method based on measurements at different instants is indicated by the first message for description.

### Embodiment 1: Process of DL-TDOA-Based Positioning Based on Measurements at Different Instants

A terminal device measures downlink reference signals at different instants. It should be noted that, the downlink reference signals at different instants may be transmitted by one access network device (for example, a satellite), or may be transmitted by a plurality of access network devices.

Manners of determining measured downlink reference signals are slightly different from each other depending on different manners of indicating a measurement time interval based on a first message. The following separately describes the manners of determining the downlink reference signals with reference to different manners of indicating the measurement time interval.

Manner 1: If the first message indicates the measurement time interval by using a specific time length, a time interval indicated by the first message may not match a transmission time interval of the downlink reference signals. In this case, to determine downlink reference signals in two measurements based on the measurement time interval indicated by the first message, two downlink reference signals that meet the measurement time interval indicated by the first message may be selected for measurement. In other words, a time interval between the two downlink reference signals may be greater than or equal to the measurement time interval. Alternatively, a second reference signal in the two reference signals is a reference signal (for example, the second reference signal or the third reference signal) that starts from an arrival time of a first reference signal in the two reference signals and arrives after the measurement time interval.

Generally, to reduce time for waiting for a reference signal, the two downlink reference signals may alternatively be two reference signals that meet the measurement time interval indicated by the first message and that are closest in time. In other words, the two downlink reference signals include a first reference signal and a second reference signal, where the second reference signal may be a reference signal that starts from an arrival time of the first reference signal and arrives first after the measurement time interval.

It should be noted that, if the time interval indicated by the first message matches the transmission time interval of the downlink reference signals, the downlink reference signals that meet the time interval may be directly selected for measurement.

Manner 2: If the first message indicates the measurement time interval by using a quantity of time domain units included between different measurements in the plurality of measurements, the measurement time interval indicated by the first message generally matches an actual transmission time interval of the downlink reference signals. In other words, the actual transmission interval between the measured downlink reference signals is the same as a quantity of time domain units indicated by the first message.

In Manner 1 and/or Manner 2, the terminal device measuring the downlink reference signals may include measuring arrival times corresponding to the downlink reference signals. For a manner of determining the arrival times of the downlink reference signals, reference may be made to the related description described above. For ease of understanding, the following describes a reference signal time difference by using an example in which a time domain unit is a subframe, a radio frame, a slot, or a symbol.

It should be noted that, a manner of determining the reference signal time difference based on another type of time domain unit is similar to the manner of determining the reference signal time difference described below. For brevity, details are not described again.

In an example in which the time domain unit is a subframe, the downlink reference signals measured by the terminal device include a first reference signal and a second reference signal, and the first reference signal is carried in a first subframe, and the second reference signal is carried in a second subframe. In this case, a time difference between an arrival time of the first reference signal and an arrival time of the second reference signal may be determined based on a time difference between a receiving instant of a start position of the first subframe and a receiving instant of a start position of the second subframe.

In an example in which the time domain unit is a radio frame, the downlink reference signals measured by the terminal device include a first reference signal and a second reference signal, and the first reference signal is carried in a first radio frame, and the second reference signal is carried in a second radio frame. In this case, a time difference between an arrival time of the first reference signal and an arrival time of the second reference signal may be determined based on a time difference between a receiving instant of a start position of the first radio frame and a receiving instant of a start position of the second radio frame.

In an example in which the time domain unit is a slot, the downlink reference signals measured by the terminal device include a first reference signal and a second reference signal, and the first reference signal is carried in a first slot, and the second reference signal is carried in a second slot. In this case, a time difference between an arrival time of the first reference signal and an arrival time of the second reference signal may be determined based on a time difference between a receiving instant of a start position of the first slot and a receiving instant of a start position of the second slot.

In an example in which the time domain unit is a symbol, the downlink reference signals measured by the terminal device include a first reference signal and a second reference signal, and the first reference signal is carried in a first symbol, and the second reference signal is carried in a second symbol. In this case, a time difference between an arrival time of the first reference signal and an arrival time of the second reference signal may be determined based on a time difference between a receiving instant of a start position of the first symbol and a receiving instant of a start position of the second symbol.

For ease of understanding, with reference to FIG. 8, the following describes a process of DL-TDOA-based positioning based on measurements at different instants in embodiments of this application by using an example in which downlink reference signals at different instants are transmitted by one access network device. It is assumed that a satellite 1 participates in positioning measurements on a terminal device 1, and the positioning measurements include three measurements. Measurement times corresponding to the three measurements are 10:00, 10:15, and 10:30, respectively.

Referring to FIG. 8, at 10:00, the satellite 1 is located at a position 1, and transmits a reference signal 1 to the terminal device 1. Correspondingly, the terminal device 1 measures an arrival time of the reference signal 1. At 10:15, the satellite 1 moves from the position 1 to a position 2, and transmits a reference signal 2 to the terminal device 1. Correspondingly, the terminal device 1 measures an arrival time of the reference signal 2, and calculates an RSTD 1 of the reference signal 1 and the reference signal 2 based on the arrival time of the reference signal 1. At 10:30, the satellite 1 moves from the position 2 to a position 3, and transmits a reference signal 3 to the terminal device 1. Correspondingly, the terminal device 1 measures an arrival time of the reference signal 3, and calculates an RSTD 2 of the reference signal 3 and the reference signal 1 based on the arrival time of the reference signal 1.

### Embodiment 2: Process of UL-TDOA-Based Positioning Based on Measurements at Different Instants

An access network device measures uplink reference signals at different instants. It should be noted that, the uplink reference signals at different instants may be transmitted by one access network device, or may be transmitted by a plurality of access network devices.

Manners of determining measured uplink reference signals are slightly different from each other depending on different manners of indicating a measurement time interval based on a first message. The following separately describes the manners of determining the uplink reference signals with reference to different manners of indicating the measurement time interval.

Manner 1: If the first message indicates the measurement time interval by using a specific time length, a time interval indicated by the first message may not match a transmission time interval of the uplink reference signals. In this case, to determine uplink reference signals in two measurements based on the measurement time interval indicated by the first message, two uplink reference signals that meet the measurement time interval indicated by the first message and that are closest in time may be selected for measurement. In other words, the two uplink reference signals include a first uplink reference signal and a second uplink reference signal, where the second uplink reference signal may be an uplink reference signal that starts from an arrival time of the first uplink reference signal and arrives first after the measurement time interval.

It should be noted that, if the time interval indicated by the first message matches the transmission time interval of the uplink reference signals, the uplink reference signals that meet the time interval may be directly selected for measurement.

Manner 2: If the first message indicates the measurement time interval by using a quantity of time domain units included between different measurements in the plurality of measurements, the measurement time interval indicated by the first message generally matches an actual transmission time interval of the uplink reference signals. In other words, the actual transmission interval between the measured uplink reference signals is the same as a quantity of time domain units indicated by the first message.

It should be noted that, in Manner 1 and/or Manner 2, the access network device measuring an uplink reference signal, for example, may include that the access network device determines a relative arrival time of the uplink reference signal based on a receiving instant of a start position of a time domain unit that carries the uplink reference signal. The relative arrival time may be an arrival time of an actual arrival time of the reference signal relative to a reference time. In some implementations, the reference time (for example, an RTOA reference time) may be pre-configured or pre-defined. For ease of understanding, the following describes a relative arrival time of a reference signal by using an example in which the time domain unit is a subframe, a radio frame, a symbol, or a slot.

It should be noted that, a manner of determining the reference signal time difference based on another type of time domain unit is similar to the manner of determining the reference signal time difference described below. For brevity, details are not described again.

In an example in which the time domain unit is a subframe, the uplink reference signals measured by the access network device include a first reference signal, and the first reference signal is carried in a first subframe. In this case, a relative arrival time of the first reference signal may be determined based on a time difference between a receiving instant of a start position of the first subframe and the reference time.

In an example in which the time domain unit is a radio frame, the uplink reference signals measured by the access network device include a first reference signal, and the first reference signal is carried in a first radio frame. In this case, a relative arrival time of the first reference signal may be determined based on a time difference between a receiving instant of a start position of the first radio frame and the reference time.

In an example in which the time domain unit is a slot, the uplink reference signals measured by the access network device include a first reference signal, and the first reference signal is carried in a first slot. In this case, a relative arrival time of the first reference signal may be determined based on a time difference between a receiving instant of a start position of the first slot and the reference time.

In an example in which the time domain unit is a symbol, the uplink reference signals measured by the access network device include a first reference signal, and the first reference signal is carried in a first symbol. In this case, a relative arrival time of the first reference signal may be determined based on a time difference between a receiving instant of a start position of the first symbol and the reference time.

For ease of understanding, with reference to FIG. 9, the following describes the process of UL-TDOA-based positioning based on measurements at different instants in embodiments of this application by using an example in which a satellite has only an NTN architecture with a transparent payload function. It is assumed that a satellite 1 participates in positioning measurements on a terminal device 1, and the positioning measurements include three measurements. Measurement times corresponding to the three measurements are 10:00, 10:15, and 10:30, respectively.

Referring to FIG. 9, at 10:00, the satellite 1 is located at a position 1, and receives a reference signal 1 transmitted by the terminal device 1, and transmits the reference signal 1 to a gNB. Accordingly, the gNB measures a relative arrival time 1 of the reference signal 1 forwarded by the satellite 1. At 10:15, the satellite 1 moves from the position 1 to a position 2, and receives a reference signal 2 transmitted by the terminal device 1, and transmits the reference signal 2 to the gNB. Accordingly, the gNB measures a relative arrival time 2 of the reference signal 2 forwarded by the satellite 1. At 10:30, the satellite 1 moves from the position 2 to a position 3, and receives a reference signal 3 transmitted by the terminal device 1, and transmits the reference signal 3 to the gNB. Accordingly, the gNB measures a relative arrival time 3 of the reference signal 3 forwarded by the satellite 1.

The foregoing describes, with reference to Embodiment 1 and Embodiment 2, a positioning measurement method to which embodiments of this application are applicable. Generally, after measurement, a terminal device or an access network device (also referred to as a first device) that performs measurement may carry a first measurement quantity in a measurement result, and transmit the measurement result to a core network device, so that the core network device calculates a location of the terminal device based on the measurement result. The following describes content included in the measurement result in embodiments of this application.

In some implementations, the measurement result includes one or more of the following information: a measurement time for each measurement of the plurality of measurements; a measurement time interval between different measurements in the plurality of measurements; a first measurement value obtained in each measurement of the plurality of measurements; satellite information of a satellite on which the plurality of measurements are based; or an RSRP measurement value of the plurality of measurements.

In some implementations, the measurement time for each measurement may be determined based on an arrival time of a reference signal. Therefore, when the arrival time of the reference signal is determined based on a receiving instant of a start position of a time domain unit that carries the reference signal, the measurement time for each measurement may also be determined based on a receiving instant of a start position of a time domain unit in which the reference signal is located.

In some implementations, the first measurement value may include, for example, an RSTD value or an RTOA value. A specific calculation manner of the first measurement value is described in detail with reference to Embodiment 1 and Embodiment 2. For brevity, details are not described herein again.

In some implementations, the satellite information of a satellite on which the plurality of measurements are based may include one or more of the following: location information of the satellite during measurement; ephemeris information of the satellite; an identity of the satellite; a delay of feeder link of the satellite; common timing advance information of the satellite; or a delay offset Kmac of the satellite.

As described above, in a joint positioning process, a location of the terminal device is required to be calculated based on a location of an access network device (for example, a TRP). In the NTN system, a location of a satellite is equivalent to a location of an access network device in a joint positioning process. Therefore, location information of the satellite during measurement may be reported in a measurement result.

As described above, in the NTN system, transmission of a signal (reference signal) requires not only a service link between a satellite and a terminal device, but also a feeder link between the satellite and a terrestrial station. In a positioning measurement process, the location of the terminal device is calculated mainly based on a propagation difference of the service link. However, a propagation difference of a feeder link included in an arrival time of the reference signal may reduce positioning accuracy of the terminal device. Therefore, a feeder link delay of a satellite may be reported in the measurement result, so that the core network device calculates the location of the terminal device without suffering influence from the feeder link.

In some implementations, the delay of the feeder link may be determined based on the common timing advance information (common TA) of the satellite and the delay offset Kmac of the satellite. For example, the delay of the feeder link is equal to a sum of the common timing advance (common TA) and the delay offset Kmac of the satellite.

In some implementations, the common timing advance may be acquired by using common timing advance information broadcast by a current serving cell. Certainly, in embodiments of this application, the common timing advance may alternatively be acquired in another manner, which is not limited in embodiments of this application.

In some implementations, the delay offset Kmac of the satellite may be acquired by using delay offset Kmac information of a satellite broadcast by a current serving cell. Certainly, in embodiments of this application, the delay offset Kmac may alternatively be acquired in another manner, which is not limited in embodiments of this application.

In some implementations, the RSRP measurement value of the plurality of measurements may include one or more of the following: an RSRP value measured based on an SSB signal, an RSRP value measured based on a PRS signal, or an RSRP value measured based on a CSI-RS signal.

It should be noted that, for a manner of defining the measurement time interval included in the measurement result, reference may be made to the foregoing description. For brevity, details are not described herein again.

In addition, in embodiments of this application, part of or all of the information included in the measurement result may alternatively be transmitted to the core network device by using another message, which is not limited in embodiments of this application.

The foregoing describes content of the measurement result in embodiments of this application, and the following describes a manner of reporting the measurement result. In some implementations, transmission of the measurement result is triggered based on a first condition.

The first condition includes one or more of the following conditions: reaching a quantity of measurement times of the positioning measurement; reaching measurement duration of the positioning measurement; reaching a measurement end time of the positioning measurement; or reaching a measurement response time of the positioning measurement, where the measurement response time is a time at which the first device transmits a measurement result of the positioning measurement to the core network device.

It should be noted that, a first message may indicate one or more of: the quantity of measurement times of the positioning measurement, the measurement duration of the positioning measurement, the measurement end time of the positioning measurement, or the measurement response time of the positioning measurement. Certainly, one or more of the above information may alternatively be configured in another manner, which is not limited in embodiments of this application.

In addition, in embodiments of this application, the first device may transmit the measurement result when the first condition is met, or the first device may also transmit the measurement result after each measurement ends. Alternatively, the first device may report the measurement result of the plurality of measurements after the plurality of measurements end, which is not limited in embodiments of this application.

The method embodiments of this application are described above in detail with reference to FIG. 1 to FIG. 9. Apparatus embodiments of this application are described below in detail with reference to FIG. 10 to FIG. 12. It should be understood that the description of the method embodiments corresponds to the description of the apparatus embodiments, and therefore, for a part that is not described in detail, reference may be made to the foregoing method embodiments.

FIG. 10 is a schematic diagram of a communications device according to an embodiment of this application. The communication device 1000 shown in FIG. 10 may be a first device. The communications device 1000 includes a receiving unit 1010.

The receiving unit 1010 is configured to receive a first message transmitted by a core network device, where the first message is used to instruct the first device to perform positioning measurement, and the positioning measurement includes a plurality of measurements corresponding to different instants.

In a possible implementation, the plurality of measurements are measurements based on one or more satellites.

In a possible implementation, the first message includes one or more of the following information: a measurement time interval between different measurements in the plurality of measurements; a quantity of measurement times of the plurality of measurements; total measurement duration of the plurality of measurements; a measurement end time of the plurality of measurements; a measurement response time of the plurality of measurements, where the measurement response time is a time at which the first device transmits a measurement result of the positioning measurement to the core network device; or indication information of a manner for determining a first measurement value of the plurality of measurements.

In a possible implementation, the measurement time interval includes one or more of the following: a time interval between adjacent measurements in the plurality of measurements; or a time interval between a measurement other than an initial measurement in the plurality of measurements and the initial measurement.

In a possible implementation, the plurality of measurements are equal-interval measurements.

In a possible implementation, the indication information is used to indicate one or more of the following: the first measurement value of the positioning measurement being determined based on adjacent measurements in the plurality of measurements; or the first measurement value of the positioning measurement being determined based on a measurement other than an initial measurement in the plurality of measurements and the initial measurement.

In a possible implementation, the apparatus further includes a transmitting unit, configured to transmit a measurement result of the positioning measurement to the core network device.

In a possible implementation, transmission of the measurement result is triggered based on a first condition, and the first condition includes one or more of the following conditions: reaching a quantity of measurement times of the positioning measurement; reaching measurement duration of the positioning measurement; reaching a measurement end time of the positioning measurement; or reaching a measurement response time of the positioning measurement, where the measurement response time is a time at which the first device transmits a measurement result of the positioning measurement to the core network device.

In a possible implementation, the measurement result includes one or more of the following information: a measurement time for each measurement of the plurality of measurements; a measurement time interval between different measurements in the plurality of measurements; a first measurement value obtained in each measurement of the plurality of measurements; satellite information of a satellite on which the plurality of measurements are based; or an RSRP measurement value of the plurality of measurements.

In a possible implementation, the measurement time for each measurement is determined based on a start position of a time domain unit in which a reference signal for each measurement is located.

In a possible implementation, the time domain unit includes one or more of the following: a subframe, a radio frame, a symbol, and a slot.

In a possible implementation, the measurement time interval includes one or more of the following: a time interval between adjacent measurements in the plurality of measurements; or a time interval between a measurement other than an initial measurement in the plurality of measurements and the initial measurement.

In a possible implementation, the first measurement value is determined based on one or more of the following information: adjacent measurements in the plurality of measurements; or a measurement other than an initial measurement in the plurality of measurements and the initial measurement.

In a possible implementation, the positioning measurement includes downlink time difference of arrival measurement, and the first measurement value includes a reference signal time difference RSTD.

In a possible implementation, the RSTD is determined based on an arrival time of a first reference signal and an arrival time of a second reference signal, and the second reference signal is a reference signal that starts from the arrival time of the first reference signal and arrives after the measurement time interval; or the second reference signal is a reference signal that starts from the arrival time of the first reference signal and arrives first after the measurement time interval.

In a possible implementation, the positioning measurement includes uplink arrival time difference measurement, and the first measurement value is used to indicate a time difference between an arrival time of a measured reference signal and a reference time.

In a possible implementation, the satellite information of the satellite includes one or more of the following: location information of the satellite during measurement; ephemeris information of the satellite; an identity of the satellite; a delay of feeder link of the satellite; common timing advance information of the satellite; or a delay offset Kmac of the satellite.

In a possible implementation, if the first device is the terminal device, the first message is an LPP message; or if the first device is an access network device, the first message is an NRPPa message.

In a possible implementation, the core network device is an LMF.

In a possible implementation, the first device is a terminal device or an access network device.

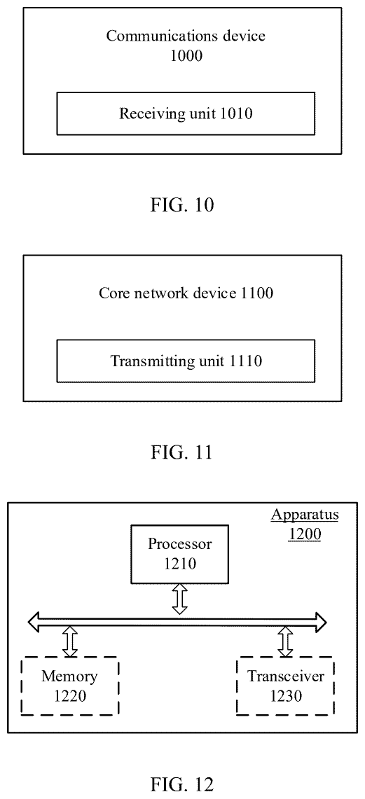

FIG. 11 is a schematic diagram of a core network device 1100 according to an embodiment of this application. The core network device 1100 shown in FIG. 11 includes a transmitting unit 1110.

The transmitting unit 1110 is configured to transmit a first message to a first device, where the first message is used to instruct the first device to perform positioning measurement, and the positioning measurement includes a plurality of measurements corresponding to different instants.

In a possible implementation, the plurality of measurements are measurements based on one or more satellites.

In a possible implementation, the first message includes one or more of the following information: a measurement time interval between different measurements in the plurality of measurements; a quantity of measurement times of the plurality of measurements; total measurement duration of the plurality of measurements; a measurement end time of the plurality of measurements; a measurement response time of the plurality of measurements, where the measurement response time is a time at which the first device transmits a measurement result of the positioning measurement to the core network device; or indication information of a manner for determining a first measurement value of the plurality of measurements.

In a possible implementation, the measurement time interval includes one or more of the following: a time interval between adjacent measurements in the plurality of measurements; or a time interval between a measurement other than an initial measurement in the plurality of measurements and the initial measurement.

In a possible implementation, the plurality of measurements are equal-interval measurements.

In a possible implementation, the indication information is used to indicate one or more of the following: the first measurement value of the positioning measurement being determined based on adjacent measurements in the plurality of measurements; or the first measurement value of the positioning measurement being determined based on a measurement other than an initial measurement in the plurality of measurements and to the initial measurement.

In a possible implementation, the apparatus further includes:
a receiving unit, configured to receive a measurement result of the positioning measurement transmitted by the first device.

In a possible implementation, transmission of the measurement result is triggered based on a first condition, and the first condition includes one or more of the following conditions: reaching a quantity of measurement times of the positioning measurement; reaching measurement duration of the positioning measurement; reaching a measurement end time of the positioning measurement; or reaching a measurement response time of the positioning measurement, where the measurement response time is a time at which the first device transmits a measurement result of the positioning measurement to the core network device.

In a possible implementation, the measurement result includes one or more of the following information: a measurement time for each measurement of the plurality of measurements; a measurement time interval between different measurements in the plurality of measurements; a first measurement value obtained in each measurement of the plurality of measurements; satellite information of a satellite on which the plurality of measurements are based; or an RSRP measurement value of the plurality of measurements.

In a possible implementation, the measurement time for each measurement is determined based on a start position of a time domain unit in which a reference signal for each measurement is located.

In a possible implementation, the time domain unit includes one or more of the following: a subframe, a radio frame, a symbol, and a slot.

In a possible implementation, the measurement time interval includes one or more of the following: a time interval between adjacent measurements in the plurality of measurements; or a time interval between a measurement other than an initial measurement in the plurality of measurements and the initial measurement.

In a possible implementation, the first measurement value is determined based on one or more of the following information: adjacent measurements in the plurality of measurements; or a measurement other than an initial measurement in the plurality of measurements and the initial measurement.

In a possible implementation, the positioning measurement includes downlink time difference of arrival measurement, and the first measurement value includes a reference signal time difference RSTD.

In a possible implementation, the RSTD is determined based on an arrival time of a first reference signal and an arrival time of a second reference signal, and the second reference signal is a reference signal that starts from the arrival time of the first reference signal and arrives after the measurement time interval; or the second reference signal is a reference signal that starts from the arrival time of the first reference signal and arrives first after the measurement time interval.

In a possible implementation, the positioning measurement includes uplink arrival time difference measurement, and the first measurement value is used to indicate a time difference between an arrival time of a measured reference signal and a reference time.

In a possible implementation, the satellite information of the satellite includes one or more of the following: location information of the satellite during measurement; ephemeris information of the satellite; an identity of the satellite; a delay of feeder link of the satellite; common timing advance information of the satellite; or a delay offset Kmac of the satellite.

In a possible implementation, if the first device is the terminal device, the first message is an LPP message; or if the first device is an access network device, the first message is an NRPPa message.

In a possible implementation, the core network device is an LMF.

In a possible implementation, the first device is a terminal device or an access network device.

In an optional embodiment, the receiving unit 1010 may be a transceiver 1240. The communications device 1000 may further include a processor 1210 and a memory 1220, which are specifically shown in FIG. 12.

In an optional embodiment, the transmitting unit 1110 may be a transceiver 1240. The core network device 1100 may further include a processor 1210 and a memory 1220, which are specifically shown in FIG. 12.

FIG. 12 is a schematic structural diagram of a communications device according to an embodiment of this application. Dashed lines in FIG. 12 indicate that a unit or module is optional. The apparatus 1200 may be configured to implement the methods described in the foregoing method embodiments. The apparatus 1200 may be a chip, a terminal device, or a network device.

The apparatus 1200 may include one or more processors 1210. The processor 1210 may support the apparatus 1200 in implementing the methods described in the foregoing method embodiments. The processor 1210 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1200 may further include one or more memories 1220. The memory 1220 stores a program, and the program may be executed by the processor 1210, to cause the processor 1210 to execute the methods described in the foregoing method embodiments. The memory 1220 may be separate from or integrated into the processor 1210.

The apparatus 1200 may further include a transceiver 1230. The processor 1210 may communicate with another device or chip by using the transceiver 1230. For example, the processor 1210 may transmit data to and receive data from another device or chip by using the transceiver 1230.

An embodiment of this application further provides a computer-readable storage medium for storing a program. The computer-readable storage medium may be applied to the terminal or the network device provided in embodiments of this application, and the program causes a computer to execute the methods performed by the terminal or the network device in various embodiments of this application.

An embodiment of this application further provides a computer program product. The computer program product includes a program. The computer program product may be applied to the terminal or the network device provided in embodiments of this application, and the program causes a computer to execute the methods performed by the terminal or the network device in various embodiments of this application.

An embodiment of this application further provides a computer program. The computer program may be applied to the terminal or the network device provided in embodiments of this application, and the computer program causes a computer to execute the methods performed by the terminal or the network device in various embodiments of this application.

It should be understood that the terms “system” and “network” in this application may be used interchangeably. In addition, the terms used in this application are used only to illustrate specific embodiments of this application, but are not intended to limit this application. The terms “first”, “second”, “third”, “fourth”, and the like in the specification, claims, and drawings of this application are used to distinguish between different objects, rather than to describe a specific order. In addition, the terms “include” and “have” and any variations thereof are intended to cover a non-exclusive inclusion.

In embodiments of this application, “indication” mentioned herein may refer to a direct indication, or may refer to an indirect indication, or may mean that there is an association relationship. For example, if A indicates B, it may mean that A directly indicates B, for example, B can be obtained from A. Alternatively, it may mean that A indirectly indicates B, for example, A indicates C, and B can be obtained from C. Alternatively, it may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, “predefined” or “pre-configured” may be implemented by pre-storing corresponding code, tables, or other forms that may be used to indicate related information in devices (for example, including a terminal device and a network device), and a specific implementation thereof is not limited in this application. For example, being pre-defined may refer to being defined in a protocol.

In embodiments of this application, the “protocol” may refer to a standard protocol in the communications field, and may include, for example, an LTE protocol, an NR protocol, and a related protocol applied to a future communications system, which is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (digital subscriber line, DSL)) manner or a wireless (for example, infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid-state drive (solid state disk, SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. A communication method, comprising:
receiving, by a first device, a first message transmitted by a core network device, wherein the first message is used to instruct the first device to perform positioning measurement, and the positioning measurement comprises a plurality of measurements corresponding to different instants.

2. The method according to claim 1, wherein the plurality of measurements are measurements that are based on one or more satellites.

3. The method according to claim 1, wherein the first message comprises one or more of following information:
a measurement time interval between n different measurements in the plurality of measurements;
a quantity of measurement times of the plurality of measurements;
total measurement duration of the plurality of measurements;
a measurement end time of the plurality of measurements;
a measurement response time of the plurality of measurements, wherein the measurement response time is a time at which the first device transmits a measurement result of the positioning measurement to the core network device; or
indication information of a manner for determining a first measurement value of the plurality of measurements.

4.-6. (canceled)

7. The method according to claim 1, wherein the method further comprises:
transmitting, by the first device, a measurement result of the positioning measurement to the core network device.

8. (canceled)

9. The method according to claim 7, wherein the measurement result comprises one or more of following information:
a measurement time for each measurement of the plurality of measurements;
a measurement time interval between different measurements in the plurality of measurements;
a first measurement value obtained in each measurement of the plurality of measurements;
satellite information of a satellite on which the plurality of measurements are based; or
an RSRP measurement value of the plurality of measurements.

10. The method according to claim 9, wherein the measurement time for each measurement is determined based on a start position of a time domain unit in which a reference signal for each measurement is located.

11.-16. (canceled)

17. The method according to claim 9, wherein the satellite information of the satellite comprises one or more of following:
location information of the satellite during measurement;
ephemeris information of the satellite;
an identity of the satellite;
a delay of feeder link of the satellite;
common timing advance information of the satellite; or a delay offset Kmac of the satellite.

18. The method according to claim 1, wherein in a case that the first device is a terminal device, the first message is an LPP message; or
in a case that the first device is an access network device, the first message is an NRPPa message.

19. The method according to claim 1, wherein the core network device is an LMF.

20. The method according to claim 1, wherein the first device is a terminal device or an access network device.

21.-40. (canceled)

41. A communications device, wherein the communications device is a first device, and the communications device comprises a memory and a processor, the memory is configured to store a computer program, and the processor is configured to execute the computer program stored in the memory to cause the communication device to perform an operation of:
receiving a first message transmitted by a core network device, wherein the first message is used to instruct the first device to perform positioning measurement, and the positioning measurement comprises a plurality of measurements corresponding to different instants.

42. The device according to claim 41, wherein the plurality of measurements are measurements that are based on one or more satellites.

43. The device according to claim 41, wherein the first message comprises one or more of following information:
a measurement time interval between different measurements in the plurality of measurements;
a quantity of measurement times of the plurality of measurements;
total measurement duration of the plurality of measurements;
a measurement end time of the plurality of measurements;
a measurement response time of the plurality of measurements, wherein the measurement response time is a time at which the first device transmits a measurement result of the positioning measurement to the core network device; or
indication information of a manner for determining a first measurement value of the plurality of measurements.

44.-60. (canceled)

61. A core network device, comprising a memory and a processor, wherein the memory is configured to store a computer program, and the processor is configured to execute the computer program stored in the memory to cause the core network device to perform an operation of:
transmitting a first message to a first device, wherein the first message is used to instruct the first device to perform positioning measurement, and the positioning measurement comprises a plurality of measurements corresponding to different instants.

62. The device according to claim 61, wherein the plurality of measurements are measurements that are based on one or more satellites.

63. The device according to claim 61, wherein the first message comprises one or more of following information:
a measurement time interval between different measurements in the plurality of measurements;
a quantity of measurement times of the plurality of measurements;
total measurement duration of the plurality of measurements;
a measurement end time of the plurality of measurements;
a measurement response time of the plurality of measurements, wherein the measurement response time is a time at which the first device transmits a measurement result of the positioning measurement to the core network device; or
indication information of a manner for determining a first measurement value of the plurality of measurements.

64.-66. (canceled)

67. The device according to claim 61, wherein the device is further configured to perform an operation of:
receiving a measurement result of the positioning measurement transmitted by the first device.

68. (canceled)

69. The device according to claim 67, wherein the measurement result comprises one or more of following information:
a measurement time for each measurement of the plurality of measurements;
a measurement time interval between different measurements in the plurality of measurements;
a first measurement value obtained in each measurement of the plurality of measurements;
satellite information of a satellite on which the plurality of measurements are based; or
an RSRP measurement value of the plurality of measurements.

70. The device according to claim 69, wherein the measurement time for each measurement is determined based on a start position of a time domain unit in which a reference signal for each measurement is located.

71.-76. (canceled)

77. The device according to claim 69, wherein the satellite information of the satellite comprises one or more of following:
location information of the satellite during measurement;
ephemeris information of the satellite;
an identity of the satellite;
a delay of feeder link of the satellite;
common timing advance information of the satellite; or
a delay offset Kmac of the satellite.

78.-87. (canceled)
